(19) United States
(12) Patent Application Publication
(10) Pub. No.: US 2019/0168488 A1
(43) Pub. Date: Jun. 6, 2019

(54) COMPOSITE PANE HAVING A MULTIPLE-PLY COMPOSITE LAYER AND METHOD FOR PRODUCTION THEREOF

(71) Applicant: SAINT-GOBAIN GLASS FRANCE, Courbevoie (FR)

(72) Inventors: Florian MANZ, AACHEN (DE); Uwe VAN DER MEULEN, NIDEGGEN (DE); Benjamin KREBS, BOCHUM (DE); Sabrina PLAHL, WUERSELEN (DE); Stephan GILLESSEN, ALSDORF (DE)

(73) Assignee: SAINT-GOBAIN GLASS FRANCE, Courbevoie (FR)

(21) Appl. No.: 16/302,511

(22) PCT Filed: May 5, 2017
(86) PCT No.: PCT/EP2017/060781

§ 371 Date: Nov. 16, 2018

(30) Foreign Application Priority Data
Jul. 13, 2016 (EP) 16179144.7

(51) Int. Cl. B32B 17/10

(52) U.S. Cl. CPC B32B 17/10036; B32B 17/10302; B32B 2307/412; B32B 2605/006; B32B 17/10761

(57) ABSTRACT

A composite pane having a multiple-ply composite layer arranged between outer and inner panes is presented. The composite layer is a laminate that includes a first thermoplastic film, a polyester film, and a second thermoplastic film. Thicknesses a, b, and c of the first thermoplastic film, the polyester film and the second thermoplastic film, are bound by the expressions: a/b=1/5 to 5/1, and c/(a+b)=25/1 to 2/1. The first thermoplastic film and the polyester film have a common edge that runs at a distance A from the edge of the second thermoplastic film, and the material of the second thermoplastic film fills the space between the common edge, the inner face of the outer pane, and the edge of the second thermoplastic film situated at the distance A from the common edge. Methods for use and production of the composite pane are also presented.

### FIELD OF THE INVENTION

The present invention relates to a composite pane having a multiple-ply composite layer.

The present invention also relates to a method for producing the composite pane having a multiple-ply composite layer.

Last but not least, the invention relates to the use of the composite pane having a multiple-ply composite layer.

### PRIOR ART

The prior art cited in the present application is incorporated into the application by reference.

Known from German patent application DE 10 2012 219 950 A1 is a laminated pane arrangement that comprises an outer glass panel that defines an outer surface and an opposite first laminate surface; an inner glass panel that defines an inner surface and an opposite second laminate surface; a first polyvinyl butyral (PVB) layer that is arranged adjacent the first laminate surface; a second PVB layer that is arranged adjacent the second laminate surface; and a polyethylene terephthalate (PET) layer that is arranged between the first PVB layer and the second PVB layer.

The outer edge of the PET layer and the outer edges of the PVB layers form a common outer edge such that the edge of the PET layer is not shielded against the environment. If the PET layer carries functional layers, for example, an electrically conductive layer, these are frequently susceptible to corrosion, greatly impairing the laminated pane arrangement in its function. Additionally, such PVB-PET-PVB layer arrangements frequently have a significant orange peel and internal errors. The term “orange peel” is used in this connection by the person skilled in the art to refer to an undesirably high surface roughness of the pane arrangement that is also visible in the finished end product and is generally perceived as annoying by the customer. The term “internal errors” is understood by the person skilled in the art to mean a variety of further optically annoying defects and foreign material inclusions occurring in the laminate. These include, among others, hair inclusions, film residues remaining when films are trimmed, as well as damage occurring during the production process as a result of fingerprints or saliva, which promote corrosion of metallic coatings in the film stack. Moreover, it is difficult to protect the PET layer during lamination by the relatively thick PVB layer. Furthermore, the PET-PVB layer arrangement is difficult to peel off from the second PVB layer such that a cutback of the PET-PVB layer arrangement is possible only with difficulty—if at all—and results in visible defects.

Accordingly, the object of the present invention was to propose a composite pane that does not have said disadvantages of the prior art.

In particular, the outer edge of the PET layer and the outer edges of the PVB layers should no longer form a common outer edge such that the edge of the PET layer was shielded against the environment. If the PET layer carried functional layers, for example, an electrically conductive layer, it should thus no longer be susceptible to corrosion such that the laminated pane arrangement would no longer be impaired in its function. Additionally, the PVB-PET-PVB layer arrangement should no longer present any orange peel and internal errors. Moreover, it should be possible to protect the PET layer during lamination by a relatively thin PVB layer. Furthermore, the PET-PVB layer arrangement should be able to be quite readily peeled from the second PVB layer such that a cutback of the PET-PVB layer arrangement was quite readily possible and thus no longer resulted in any visible defects.

Last but not least, the object of the present invention was to provide a method with which the composite panes could be produced quickly, problem free, defect free, and outstandingly reproducibly.

These and other objects are accomplished according to the proposal of the invention by the composite pane and the method for its production with the features of the independent claims. Advantageous embodiments of the invention are disclosed through the features of the subclaims.

### DETAILED DESCRIPTION OF THE INVENTION

The invention relates to a composite pane, in particular a composite pane for use in the automotive sector. Preferably, the pane is transparent, i.e., has transmittance greater than 0% in the visible spectral range. The invention is thus suitable both for panes in the through-vision area, for example, windshields, side windows, and rear windows, as well as for panes with low transparency, for example, roof panels.

The composite pane has at least one, in particular, one, multiple-ply composite layer between at least one, in particular, one, outer pane and at least one, in particular, one, inner pane.

The at least one, in particular, one, multiple-ply composite layer is a laminate that has at least one, in particular, one, first thermoplastic film adhering to the inner face of the at least one outer pane.

The laminate further has at least one, in particular, one, polyester film on the surface of the at least one thermoplastic film opposite the inner face of the outer pane.

In addition, the laminate has at least one, in particular, one, second thermoplastic film positioned between the at least one polyester film and the top of the inner pane opposite the inner face of the outer pane.

In the laminate, the thickness ratios of the films are set as follows:
(first thermoplastic film):(polyester film)=(1:5) to (5:1), preferably (1:2.5) to (2.5:1), in particular (1:1); and
(second thermoplastic film):[(first thermoplastic film)+(polyester film)]=(25:1) to (2:1), preferably (9:1) to (2.5:1), in particular (4:1).

The thicknesses of the thermoplastic films and of the polyester film can vary widely and, consequently, be ideally adapted to the requirements of the individual case. Preferably, the first thermoplastic film is 20 μm to 200 μm thick, more preferably 40 μm to 110 μm, in particular 40 μm to 60 μm or 90 μm to 110 μm. Preferably, the polyester film is 10 μm to 130 μm thick, more preferably 20 μm to 60 μm, in particular 40 μm to 60 μm. Preferably, the second thermoplastic film is 150 μm to 1000 μm thick, more preferably 350 μm to 850 μm, and in particular 370 μm to 510 μm or 750 μm to 845 μm.

The at least one first thermoplastic film and the at least one polyester film have a common edge that runs at a distance A parallel or substantially parallel to the edge of the at least one second thermoplastic film.

Here, and in the following, “substantially” means that the property in question or the value in question can deviate from the exact value for property but only to an extent that the function in question, which is defined by the value or the property, is not disturbed or damaged.

The distance A can vary widely and, consequently, be ideally adapted to the requirements of the individual case. Preferably, the distance A is between 1 mm and 400 mm, particularly preferably 5 mm to 250 mm.

The material of the at least one second thermoplastic film fills the space between said common edge, the inner face of the at least one outer pane, and the edge of the at least one second thermoplastic film situated at the distance A from the common edge and fuses during the lamination process with the material of the at least one first thermoplastic film such that the common edge is isolated from the environment of the composite pane.

The composite pane according to the invention is preferably transparent, with the transmittance of the pane greater than 0% in the visible spectral range. For panes in the through-vision region of a vehicle glazing, minimum legal requirements apply for transmittance in the visible spectral range. In the case of windshields, transmittance of at least 70% is required in the regulations ECE-R43, ANSI Z 26.1, and CCC/CNCA-04. A preferred embodiment of the invention is a windshield corresponding to this requirement. By means of the laminate structure according to the invention, the internal errors occurring in the production process as well as the surface roughness (“orange peel”) optically discernible after lamination can be minimized. However, undesirably high surface roughness makes a negative impression on the observer, particularly in the case of panes with low transmittance. One advantageous embodiment of the composite pane according to the invention is a rear window or roof panel. In modern automotive engineering, large-area roof glazings are a frequently used design feature. In order to avoid excessive heating of the vehicle interior, these panes are usually darkened or can be darkened by switchable layer-stack elements known to the person skilled in the art. Even optical inhomogeneities discernible only in the darkened state are experienced by the customer as quality defects. These are minimized or eliminated by means of the layer structure of the composite pane according to the invention.

In a preferred embodiment, the composite pane according to the invention has transmittance of 0.5% to 50%, preferably 3% to 30%, particularly preferably 5% to 27% in the visible spectral range of light. Preferably, this case involves a rear window or a roof panel, in particular a vehicle roof panel.

The at least one outer pane and/or the at least one inner pane is/are constructed from a material that is constructed from glass and/or at least one plastic, in particular a clear, rigid plastic, or is made therefrom.

Preferably, the glass is selected from the group consisting of flat glass, float, quartz glass, borosilicate glass, and soda lime glass.

Preferably, the clear, rigid plastic is selected from the group consisting of polyethylene, polypropylene, polycarbonate, polymethyl methacrylate, polystyrene, polyamide.

The thickness of the at least one outer pane and/or of the at least one inner pane can vary widely and thus be ideally adapted to the requirements of the individual case. Preferably, panes with the standard thicknesses from 0.3 to 25 mm, more preferably from 1.2 mm to 3.5 mm, are used for motor vehicles.

The size of the at least one outer pane and/or of the at least one inner pane can also vary widely and is governed by the size of the composite pane according to the invention. For example, they can have the areas from 200 cm² up to 20 m² customary in automotive engineering and architecture.

The at least one outer pane and the at least one inner pane can have any outline. Thus, they can be triangular, quadrilateral, rhomboid, trapezoidal, pentagonal, or hexagonal, optionally with rounded corners, round, oval, elliptical, or kidney-shaped, optionally with rounded edges.

The at least one outer pane and/or the at least one inner pane can have any three-dimensional shape. Preferably, the three-dimensional shape has no shadow zones such that it can, for example, be coated by cathodic sputtering. Preferably, the panes are planar or slightly or greatly curved in one or a plurality of spatial directions. In particular, planar panes or substantially planar panes are used. The panes can be colorless or colored and/or contain IR- and/or UV-radiation-absorbing pigments. For optical reasons, slightly tinted outer panes can be used, as a result of which the TTS (cf. DIN EN ISO 13837 Heat) drops slightly.

The at least one polyester film of the at least one composite layer is preferably a polyethylene terephthalate film (PET) or a polybutylene terephthalate film, but more preferably a polyethylene terephthalate film.

The at least one first and/or at least one second thermoplastic film are constructed from a thermoplastic selected from the group consisting of polyvinyl butyral (PVB), ethylene vinyl acetate (EVA), polyurethane (PU), polypropylene (PP), polyacrylate, polyethylene (PE), polycarbonate (PC), polymethyl methacrylate (PMMA), polyvinyl chloride (PVC), polyacetate resin, casting resins, polyacrylates, fluorinated ethylene-propylene copolymers, polyvinyl fluoride, and/or ethylene-tetrafluoroethylene copolymers or they are made from at least one of these thermoplastics.

PVB is particularly preferably used. In particular, the PVB is free or substantially free of plasticizers.

The first and/or the second thermoplastic film can be colored, wherein the color and brightness can be freely selected within wide limits. The second thermoplastic film can absorb UV and/or IR radiation.

At least one functional layer can be arranged between the at least one first thermoplastic film and the polyester film and/or between the polyester film and the second thermoplastic film. This at least one functional layer can absorb radio, IR, and/or UV radiation and/or be electrically conductive and/or be colored. For example, it can function as a pane heater.

In a preferred embodiment, an electrically conductive functional layer is applied on the polyester film, for example, by means of physical vapor deposition or other processes known to the person skilled in the art. The electrically conductive functional layer has high absorption in the infrared range of the light spectrum and thus prevents heating up of the interior behind it. Such layers are commonly referred to as so-called “IR layers” and are familiar to the person skilled in the art. Optionally, these layers can also be used for heating the pane.

Additional films, for instance, switchable elements based on liquid crystals, suspended particles, or electrochromic layer structures, can be used between the second thermoplastic film and the inner pane.

In a possible embodiment, switchable elements installed in the composite pane are even operable directly via sensors laminated into the composite pane.

The composite pane can also have, in a possible embodiment, sound damping properties. To this end, acoustically damping thermoplastic films are preferably used.

The composite pane can be produced using various prior art methods. However, it is preferably produced using the method according to the invention.

The method according to the invention is characterized by the following steps:
(a) providing at least one, in particular, one, inner pane having a top,
(b) covering the top with at least one, in particular, one, second thermoplastic film all the way to the edge region of the subsequent composite pane,
(c) completely covering the surface of the at least one second thermoplastic film opposite the surface with at least one, in particular, one, polyester film,
(d) completely covering the free surface of the at least one polyester film with at least one, in particular, one, first thermoplastic film,
(e) cutting the first thermoplastic film and the polyester film with a cutting device, preferably a laser or a diamond knife, at a distance A from the edge of the at least one second thermoplastic film,
(f) removing the strip of film from the at least one first thermoplastic film and the polyester film such that these two films form a common edge, and a free horizontal surface of the width A of the at least one second thermoplastic film is exposed, and
   (g) pressing on the at least one, in particular, one, outer pane with a pressure D, wherein the inner face of the at least one outer pane makes contact with the top of the at least one first thermoplastic film and wherein the free space between the common edge, the inner face, and the free surface of the at least one second thermoplastic film is filled by inflow of the material of the at least one second thermoplastic film in the direction of the common edge and the inner face, and the composite pane results.

The cutting of the first thermoplastic film and of the polyester film in step (e) is done perpendicular to the surface of the first thermoplastic film.

In a preferred embodiment, the pressing on (g) is done at relatively high temperatures and under a vacuum. Suitable devices for this, for instance, vacuum bags, are customary and known and need not be explained in greater detail here. Preferably, the lamination is done in the autoclave method.

The composite pane according to the invention, in particular the composite pane according to the invention produced using the method according to the invention, can ideally be used as a movable and immovable functional and/or decorative individual piece and/or as a built-in component in furniture, appliances, and buildings, as well as in means of transportation for transportation on land, in the air, or on water, such as aircraft, watercraft, trains, and motor vehicles, but, in particular, in motor vehicles, for example, as a windshield, rear window, and side window and/or roof panel, but in particular as a roof glazing.

Of course, the features mentioned above and explained in greater detail in the following can be used not only in the combinations and configurations indicated but also in other combinations and configurations or in isolation without departing from the scope of the present invention.

### BRIEF DESCRIPTION OF THE FIGURES

The invention is now explained in detail using exemplary embodiments, with reference made to the accompanying figures. They depict in simplified, not-to-scale representation:

FIG. 1 a vertical longitudinal section through the edge region 1.3 of the composite pane 1;

FIG. 2 a vertical longitudinal section through the edge region 1.3 of an intermediate stage 1a during production of the composite pane 1;

FIG. 3 a vertical longitudinal section through the edge region 1.3 of an intermediate stage 1b during production of the composite pane 1;

FIG. 3a a top plan view of the intermediate stage 1b during production of the composite pane 1

FIG. 4 a vertical longitudinal section through the edge region 1.3 of an intermediate stage 1c during production of the composite pane 1.

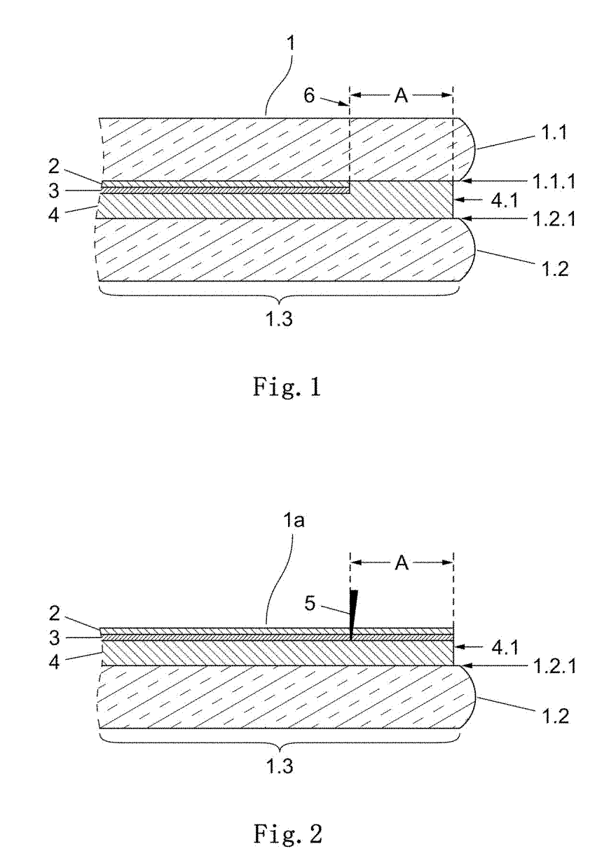

In FIGS. 1 to 4, the reference characters have the following meaning:
1 composite pane having a multiple-ply composite layer
1a, 1b,
1c intermediate stages in the production of the composite pane 1
1.1 outer pane of the composite pane 1
1.1.1 inner face of the outer pane 1.1
1.2 inner pane of the composite pane 1
1.2.1 top of the inner pane 1.2
1.3 edge region of the composite pane 1
2 20-μm- to 200-μm-thick thermoplastic film
3 10-μm- to 130-μm-thick polyester film
4 150-μm- to 1000-μm-thick thermoplastic film
4.1 edge of the thermoplastic film 4
4.2 exposed horizontal surface of the thermoplastic film 4
5 cutting device
6 common edge of the thermoplastic film 2 and the polyester film 3
7 direction of flow of the material of the thermoplastic film 4
A distance of the common edge 6 from the edge 4.1 of the thermoplastic film 4
D pressing-on pressure

### DETAILED DESCRIPTION OF THE DRAWINGS

FIG. 1

FIG. 1 depicts a vertical longitudinal section through the edge region 1.3 of the composite pane 1.

The composite pane 1 was formed by an outer pane 1.1 made of tempered float glass with a thickness of 2.1 mm. The edges of the outer pane 1.1 were rounded. The outer pane 1.1 had an inner face 1.1.1, which was associated with the multiple-ply composite layer 2,3,4.

In addition, the composite pane 1 was formed by an inner pane 1.2 of the same composition and dimensions. The edges of the inner pane 1.2 were likewise rounded. The inner pane 1.2 had a top 1.2.1, which was associated with the multiple-ply composite layer 2,3,4.

The inner face 1.1.1 of the outer pane 1.1 was in direct contact with a 50-μm-thick, plasticizer-free PVB film 2. This was underlaid with a 50-μm-thick PET film 3. The PVB film 2 and the PET film 3 had a common edge 6, which was situated at a distance A=1 cm from the edge 4.1 of the underlaid 380-μm-thick PVB film 4. The PVB film 4 lay on the top 1.2.1 of the inner pane 1.2. The material of the PVB film 4 completely filled the space between the edge 6 and the inner face 1.1.1 of the outer pane 1.1 on the distance A. By this means, the common edge 6 of the PVB film 2 and the PET film 3 was completely isolated from the environment of the composite pane 1. Thus, if the PET film 3 carried functional layers, for example, an electrically conductive layer, these layers were no longer susceptible to corrosion such that the laminated pane arrangement was no longer impaired in its function. In addition, the PVB-PET-PVB layer arrangement 2,3,4 had no orange peel and no internal errors. Moreover, it was possible to protect the PET film 3 during lamination by the relatively thin PVB film 2. Furthermore, the PET-PVB layer arrangement 2,3 could be quite readily removed from the second PVB film 4 such that a cutback of the PET-PVB layer arrangement 2,3 was quite readily possible, and thus no longer resulted in visible defects.

FIGS. 2 to 4

FIGS. 2, 3, and 4 schematically depict the production of the composite pane 1 using vertical longitudinal sections of the edge region 1.3.

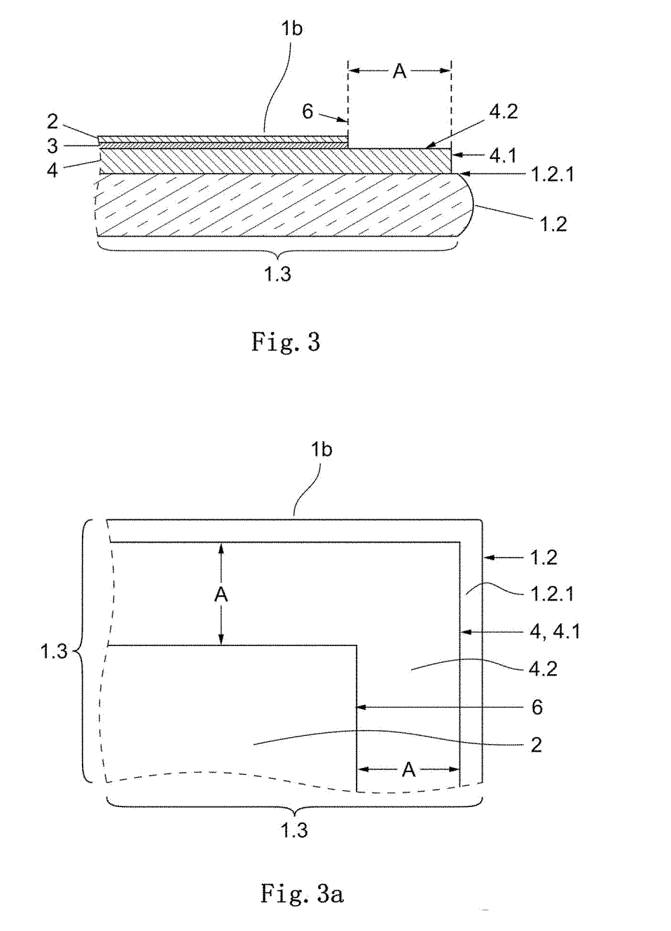

FIG. 3a depicts, for clarification of the method, the plan view of the intermediate stage 1b during production of composite pane 1.

The materials and dimensions detailed in the case of FIG. 1 were used.

FIG. 2: Intermediate Stage 1a

The PVB film 4 was laminated onto the top 1.2.1 of the inner pane 1.2. Then, the PET film 3 and the PVB film 2 were laminated onto the exposed top of the PVB film 4 such that the intermediate stage 1a resulted.

FIG. 3: Intermediate Stage 1b

For producing the intermediate stage 1b, the intermediate stage 1a was cut with a diamond knife 5 (depicted in FIG. 2) at the distance A from the edge 4.1 of the PVB film 4 all the way to the surface of the PVB film. The cut-off PVB-PET film piece 2,3 was removed, without damaging the now exposed, free, horizontal surface 4.2 of the PVB film 4. The PVB film 2 and the PET film 3 now formed a common edge 6 at a distance A from the edge 4.1 of the PVB film 4.

This arrangement is illustrated again referring to FIG. 3a.

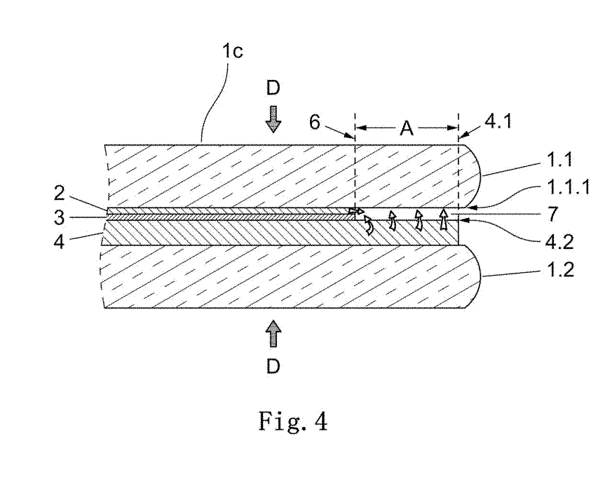

FIG. 4: Intermediate Stage 1c

The outer pane 1.1 with the inner face 1.1.1 was placed on the arrangement of the intermediate stage 1b of FIGS. 3 and 3a such that it made contact with the PVB film 2. Then, the entire arrangement was pressed together in a vacuum bag in heat and under a vacuum with the pressure D. Here, the hollow space between the common edge 6, the exposed surface 4.2, and the inner face 1.1.1 of the outer pane 1.1 was filled in that the material of the PVB film 4 flowed in the flow direction 7 into the hollow space and fused with the material of the PVB film 2. After cooling, release of the pressure D, and admission of air into the vacuum bag, the composite pane 1 according to the invention with the advantageous features described with regard to FIG. 1 resulted.

1.-15. (canceled)

16. A composite pane, comprising:
an inner pane;
an outer pane; and
at least one multiple-ply composite layer arranged between the outer pane and the inner pane, wherein the at least one multiple-ply composite layer is a laminate, including
a first thermoplastic film adhered to an inner face of the outer pane,
at least one polyester film adhered to a surface of the first thermoplastic film opposite the inner face of the outer pane, and
a second thermoplastic film positioned between the at least one polyester film and a top surface of the inner pane that is opposite the inner face of the outer pane,
wherein a ratio, a/b, of a thickness a of the first thermoplastic film to a thickness b of the at least one polyester film, is in a range from 1/5 to 5/1,
wherein a ratio, c/(a+b), of a thickness c of the second thermoplastic film to a sum of the thickness a and the thickness b, is in a range from 25/1 to 2/1,
wherein the first thermoplastic film and the at least one polyester film have a common edge that runs at a distance A parallel to an edge of the second thermoplastic film, and
wherein a material of the second thermoplastic film fills a space between the common edge, the inner face of the outer pane, and the edge of the second thermoplastic film, and is fused with a material of the first thermoplastic film so that the common edge is isolated from an environment of the composite pane.

17. The composite pane according to claim 16, wherein:
the thickness a is in a range from 20 μm to 200 μm,
the thickness b is in a range from 10 μm to 130 μm, and
the thickness c is in a range from 150 μm to 1000 μm.

18. The composite pane according to claim 16, wherein at least one of the outer pane and the inner pane is constructed of a material selected from a group consisting of: a) flat glass, b) float glass, c) quartz glass, d) borosilicate glass, e) soda lime glass, f) polyethylene, g) polypropylene, h) polycarbonate, i) polymethyl methacrylate, j) polystyrene, k) polyamide, l) polyester, m) polyvinyl chloride, and n) a combination of any one of a)-m).

19. The composite pane according to claim 16, wherein at least one of the first thermoplastic film, the second thermoplastic film, and the at least one thermoplastic film is constructed of a plastic selected from a group consisting of: a) polyvinyl butyral (PVB), b) ethylene vinyl acetate (EVA), c) polyurethane (PU), d) polypropylene (PP), e) polyacrylate, f) polyethylene (PE), g) polycarbonate (PC), h) polymethyl methacrylate (PMMA), i) polyvinyl chloride (PVC), j) polyacetate resin, k) casting resins, l) polyacrylates, m) fluorinated ethylene-propylene copolymers, n) polyvinyl fluoride, and o) ethylene-tetrafluoroethylene copolymers.

20. The composite pane according to claim 16, wherein the plastic is polyvinyl butyral (PVB).

21. The composite pane according to claim 16, wherein the at least one polyester film is a polyethylene terephthalate film (PET).

22. The composite pane according to claim 16, wherein the first thermoplastic film is free of plasticizers.

23. The composite pane according to claim 16, wherein the thickness a is in a range from 40 μm to 110 μm.

24. The composite pane according to claim 16, wherein the thickness b is in a range from 10 μm to 130 μm.

25. The composite pane according to claim 16, wherein the multi-ply composite layer further comprises at least one functional layer arranged between the first thermoplastic film and the at least one polyester film.

26. The composite pane according to claim 16, wherein the multi-ply composite layer further comprises at least one functional layer arranged between the second thermoplastic film and the top surface of the inner pane.

27. The composite pane according to claim 25, wherein the at least one functional layer is configured to absorb one or more of: radio radiation, infrared radiation, and UV radiation and/or is electrically conductive and/or is colored.

28. The composite pane according to claim 25, wherein the at least one functional layer is electrically conductive.

29. The composite pane according to claim 25, wherein the at least one functional layer is colored.

30. A method for producing a composite pane, the method comprising:
providing an inner pane having a top surface;
covering the top surface with a second thermoplastic film up to a region that defines an edge of the second thermoplastic film;
completely covering a surface of the second thermoplastic film opposite the top surface with at least one polyester film;
completely covering a free surface of the at least one polyester film with a first thermoplastic film;
using a cutting device, vertically cutting the first thermoplastic film and the at least one polyester film at a distance A from the edge;
based on the cutting, removing a strip of the first thermoplastic film and the at least one polyester film having a width A, thereby forming a common edge of the first thermoplastic film and the at least one polyester film, and exposing a free horizontal surface of width A of the second thermoplastic film; and
arranging an inner face of an outer pane to make contact with a top surface of the first thermoplastic film, and pressing the outer pane with a pressure D, thereby filling a free space between the edge of the second thermoplastic film, the inner face of the outer pane, and the top surface of the inner pane by inflow of a material of the second thermoplastic film, and forming the composite pane.

31. The method according to claim 30, wherein the pressing is done at relatively high temperatures and under a vacuum.

32. A method, comprising:
providing a composite pane according to claim 16; and
using the composite pane in a means of transportation as one or more of: a windshield, a side window, a rear window, and roof panel.

33. The method according to claim 32, wherein the means of transportation comprises motor vehicles.
